(19) United States
(12) Patent Application Publication
(10) Pub. No.: US 2008/0016739 A1
(43) Pub. Date: Jan. 24, 2008

(54) Easy loader card insertion device

(76) Inventor: Scott Malcolm, Thorold (CA)

Correspondence Address: EDWARD H. OLDHAM, 20 JAMESON DRIVE, DUNDAS, ON, L9H 5A2, US

(21) Appl. No.: 11/474,264

(22) Filed: Jun. 26, 2006

Related U.S. Application Data
(60) Provisional application No. 60/802,135, filed on May 22, 2006.

(51) Int. Cl. G09F 3/18

(52) U.S. Cl. 40/649

(57) ABSTRACT

An insertion device is described which enables an operator to easily insert flat cards into the pockets provided in display devices. The device has the general shape of a miniature dust pan having a flat floor and which has a tapered nose for insertion into said pockets. The device includes shallow vertical sides which slope upwardly from the floor of the device adjacent said nose so as to lift the upper surface of the pocket when inserted therein. A card is then laid on the device, the dimensions of the card, insertion device, and the pocket having been previously decided, and the card is now slid along the floor of the insertion device into the pocket.

### FIELD OF THE INVENTION

This application relates to a device which enables the user to quickly insert photographs, post cards, sports cards, stamps and other valuable items of a similar flat nature into a common plastic pocket display device such as a photo album etc. without causing damage to the item being inserted in the display device

### BACKGROUND OF THE INVENTION

In the past, photographs, sport cards etc. have been mounted in plastic display devices such as books, sheets, etc. by inserting the display item (sports card etc.) manually into a “pocket” formed in the plastic display device. This can be a time consuming adventure fraught with obstacles. If the item being inserted has substantial thickness or an irregularly shaped perimeter, the time required to successfully insert the item without damaging the item may be inordinate.

The opening provided in the display device may be difficult to locate or it may not yield as readily as expected when located. If any difficulty is encountered during the insertion process damage may occur to the item being inserted. In certain instances, the display item may have substantial commercial value and any resulting damage may detract significantly from the value of the article. Several devices have been developed in the past to assist in inserting display items into plastic pocket display devices.

Most skilled and experienced card installers will agree that the insertion of a display item such as postcards, sports cards etc. into a plastic display pocket can test the agility and patience of the experienced installer who has a keen eye and steady hand; when age and infirmity are introduced to this task, the result may be that it is almost impossible to insert the photograph or sports card into the plastic pocket without damaging the display item.

Modern manufacturing and storage techniques result in display devices having perforated display pockets wherein the edges of the openings remain stuck together and offer resistance to the opening of the pocket for the insertion of the display item.

It is to overcome these problems that the present invention is addressed.

### SUMMARY OF THE INVENTION

The device which is the subject of this invention, has a shape resembling a miniature dust pan. It may be of a substantially flat nature having slightly raised external edges and which may be inserted into the plastic pocket of a display device, such as a photo album, sports card display, pocket, etc. It will prepare the pocket for the subsequent insertion of the display item into the pocket. The display item whose dimensions are such as to fit nicely into the device, is first laid upon the flat surface of the item inserter (which has already been inserted into the display pocket of the display device) and is subsequently pushed into position in the plastic display pocket.

The result is that the photograph, sports card or stamp etc. has now been inserted into the display pocket without any damage being caused to the inserted display item.

### PRIOR ART

### U.S. Patents:

U.S. Pat. No. 6,824,846 issued Nov. 30, 2004
U.S. Pat. No. 5,375,352 issued Dec. 27, 1994
U.S. Pat. No. 5,245,775 issued Sep. 21, 1993
U.S. Pat. No. 5,159,964 issued Nov. 3, 1992

### BRIEF DESCRIPTION OF THE DRAWINGS

FIG. 1 represents a plan view of the device of this invention;

FIG. 2 represents an elevational view of the device of this invention;

FIG. 3 represents an end view of the device of this invention;

FIG. 4 is a perspective view of the applicant's invention;

FIG. 5 is a perspective view of the display device of this invention having a card partially inserted into a display pocket;

FIG. 6 is a perspective of similar device as FIG. 5 having a card further inserted into a display pocket.

### DESCRIPTION OF THE PREFERRED EMBODIMENT

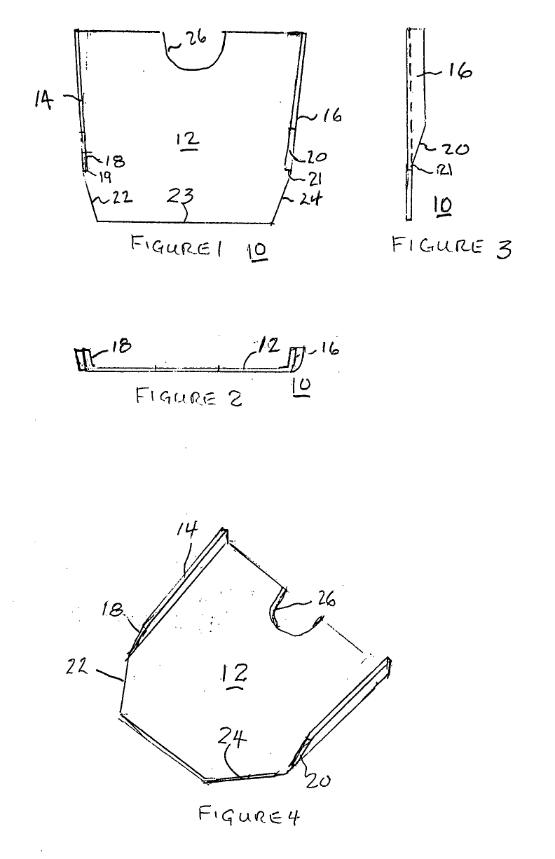

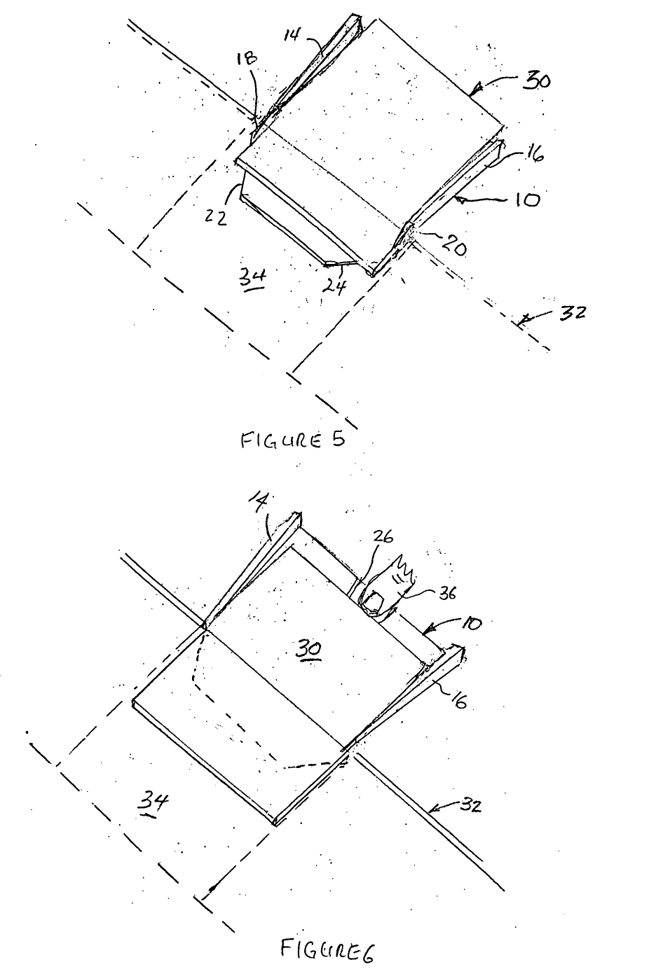

The device 10 of this invention is shown in FIGS. 1, 2, 3 and 4. Here device 10 may be fabricated from a variety of materials such as metals, plastic or stiff card stock. It matters only that device 10 retains it shape and stiffness. Device 10 is a substantially flat device having the shape of miniature dustpan. Device 10 has a central flat portion 12 which gives rise to a pair of upturned edges 14 and 16 which are tapered inwardly toward nose 23 of device 10. The edges 14 and 16 also slope downwardly at 18 and 20 to blend in with the flat surface of central portion 12 at 19 and 21 (see FIGS. 1 and 3).

The central portion 12 is again tapered at 22 and 24 to permit easier insertion into the plastic display pocket.

A finger cut out 26 is provided to permit the device user to slide the display item more deeply into the plastic pocket provided for the purpose.

FIG. 5 shows the device 10 inserted into the pocket 34 of a transparent plastic display 32. Card 30 has been slid into place on the surface 12 of device 10 which has previously been inserted into the opening provided in pocket 34. The tapered portions 18 and 20 hold open the opening of pocket 34 so that when card 30 is pushed downwardly, it will enter the opening in pocket 34 without contacting the pocket edges.

FIG. 6 shows card 30 being inserted further into pocket 34 with finger 36 located in finger slot 26. Device 10 may be removed and the final insertion of card 30 is performed, or device 10 may be left in place during the final positioning process.

The device may be used to load such items as stamps, photographs, post cards and sports cards etc. into display devices such as sleeves, albums, scrap books, etc. Each different display item will be fitted with a loading device as described in this application of a suitable size, depending on the dimensions of the item being inserted. Of course the pocket dimensions must be matched to the device being inserted.

The easy loader serves to open the pocket in the display device so that valuable display items are not damaged during insertion.

The finger cut out allows the display item to be inserted more deeply into the display device so that damage to the card undergoing insertion into the pocket is minimized.

The easy loader 10 can be utilized to separate the sheets forming the display pocket when the sheets are attracted to each other by static electricity. The easy loader will easily separate the adjacent clinging sheets.

The aged and infirm will greatly benefit by the use of the easy loader. For those individuals whose trembling hands makes the insertion of display items into a display pocket difficult, if not impossible, the easy loader will help alleviate that situation.

First the operator may insert the easy loader into the pocket to determine if the dimensions of the pocket and the easy loader are in agreement. If the easy loader does not fit in the pocket, it signals the installer that the item, about to be installed, will not fit either. This saves wear and tear on the display items sought to be inserted in the display device.

If desired the easy loader may be mounted on a stationary pedestal for use in applications where a large number of display items are to be inserted into pockets.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

What is claimed:

1. An insertion device to be used in assisting an operator in the insertion of flat cards such as sports cards, post cards, stamps and/or photographs into a pocket of a display device comprising:
a relatively flat insertion device having the general shape of a miniature dust pan,
said device having a rather flat central portion having upturned edges extending along each side of said central portion, said edges rising from said flat portion to a predetermined height;
said device having a flat tapered forward portion for insertion into said pocket, said edges having sloping portions adjacent said tapered forward portion to open said pocket when said tapered forward portion is inserted into said pocket,
and a cut out formed in said flat surface remote from said tapered forward portion extending a second predetermined distance toward said forward portion.

2. An insertion device as claimed in claim 1 wherein said sloping portions of said edges are located to the rear of said tapered forward portion of said device.

3. A device as claimed in claims 1, or 2 which is formed of a metallic material.

4. A device as claimed in claims 1, or 2 which is plastic.

5. A device as claimed in claims 1, or 2 which is cardboard.

6. A device as claimed in claims 1, or 2 which has a coupling device mounted on said insertion device for holding said device in a third predetermined operating position.

7. An insertion guide for the insertion of relatively flat cards with a display pocket of a display device comprising:
a relatively flat insertion device having the general shape of a miniature dust pan, said device having a relatively flat central portion, having an upper and a lower surface,
a said surface having sides and a forward and a rear portion,
said sides being integrally attached to said central flat portion and extending partially from said rear portion to said forward portion of said flat portion; said sides extending vertically to a predetermined height,
a forward portion having a tapered nose for insertion into said pocket,
said sides having sloping portions, sloping downwardly toward said upper surface at said forward portion.

8. A device as claimed in claim 7 which is fabricated from metal.

9. A device as claimed in claim 7 which is fabricated from plastic.

10. A device as claimed in claim 7 which is fabricated from cardboard.

11. A device as claimed in any of claims 7, 8, 9 or 10 in which an opening of a predetermined configuration in the rear portion of said device.

12. A device as claimed in claims 7, 8, 9, 10 or 11 in which a mounting means is secured to said device to enable an operator to maintain the device in an operative position.

13. The process of inserting a card into a display envelope, wherein said display envelope is provided with an opening for the insertion of a card comprising:
providing a suitable display envelope having an opening therein,
inserting the forward portion of the device of claims 1 or 7 into said opening,
placing a card on the surface of the device of claims 1 or 7,
sliding said card on said device until it is completely inserted into said display envelope, removing said device from said opening.
